(19) United States
(12) Patent Application Publication
(10) Pub. No.: US 2026/0323379 A1
(43) Pub. Date: Oct. 15, 2026

(54) ENHANCED SCHEDULING REQUESTS AND BUFFER STATUS REPORTS

(71) Applicant: Telefonaktiebolaget LM Ericsson (publ), Stockholm (SE)

(72) Inventors: Alexey SHAPIN, Linköping (SE); Bikramjit SINGH, Raasepori (FI); Fabian DE LAVAL, Täby (SE); Jonas FRÖBERG OLSSON, Ljungsbro (SE); Richard TANO, Stockholm (SE)

(73) Assignee: Telefonaktiebolaget LM Ericsson (publ), Stockholm (SE)

(21) Appl. No.: 19/101,295

(22) PCT Filed: Aug. 14, 2023
(86) PCT No.: PCT/SE2023/050818

§ 371 Date: Feb. 5, 2025

Related U.S. Application Data
(60) Provisional application No. 63/398,339, filed on Aug. 16, 2022.

(51) Int. Cl. H04W 28/02; H04W 72/12

(52) U.S. Cl. CPC H04W 28/0278; H04W 72/12

(57) ABSTRACT

A method of operating a wireless device that is configured for transmission of a data flow within a wireless communication network is provided. The method includes receiving a data packet of the data flow from an application, wherein the data flow includes application data units, ADUs, each of which includes a plurality of related data packets, and storing the data packet in a buffer of the wireless device. The method further includes obtaining ADU related information about a relationship between the data packet and a related ADU to which the data packet belongs, and notifying a network node of the wireless communication network about the data packet based on the ADU related information. Related network node methods, wireless devices and network nodes are disclosed.

### TECHNICAL FIELD

The present disclosure relates to wireless communication networks, and in particular to systems and methods for controlling data flow within a wireless communication network. A wireless device, a network node, and computer program products thereof are also provided.

### BACKGROUND

There is currently ongoing work in the 3GPP SA2 group on architecture enhancement for extended reality (XR) and media services which is aiming to introduce additional application awareness in radio access networks (RAN). This additional information can be used by a user equipment (UE) and gNodeBs (gNB) as well as being propagated via radio interface in different form of signaling. The goal of application awareness is improving system efficiency and capacity. One of the potential enhancements for signaling is uplink control channel where scheduling request and buffer status report can potentially carry some additional information related to XR or media traffic.

The Rel-18 SA2 study item on XR and media services provides the following reasoning for enhancements. In the 5G era, mobile media services, cloud alternate reality (AR)/virtual reality (VR), cloud gaming, video-based tele-control for machines or drones, are expected to contribute more and more traffic to 5G network. All media traffics, in spite of which codec was used, have some common characteristics. These characteristics can be very useful for better transmission control and efficiency. However, currently 5GS uses common quality of service (QoS) mechanisms to handle media services together with other data services without taking full advantage of these information. For example, packets within a frame may have dependencies with each other if the associated application needs all associated packets for decoding a frame. Hence loss of one packet will make other correlated packets useless, even they are successfully transmitted. For example, XR applications impose requirements in terms of Media Units (also referred to as Application Data Units or ADUs), rather than in terms of single protocol data units (PDUs).

Similarly, packets of a video stream having different frame types (I/P frame) or even different positions in a Group of Pictures (GoP) may provide different contributions to the user experience. A layered QoS handling within the video stream can potentially relax the requirement, thus leading to higher efficiency.

Certain objectives for further study are articulated in [1]. One objective is to enhance the QoS framework to support media units granularity (e.g., video/audio frame/tile, Application Data Unit, control information), where media units consist of PDUs that have the same QoS requirements. Another objective is to support differentiated QoS handling considering different importance of media units. e.g., eligible drop packets belong to less important media units to reduce the resource wasting.

In recent discussions in 3GPP, the term “PDU set” is used instead of media unit or application data unit. However, these terms essentially refer to same concept, which is a set of related PDUs that have some defined dependencies.

### Scheduling Request

A Scheduling Request (SR) is used for requesting uplink shared channel (UL-SCH) resources for new transmission. A medium access control (MAC) entity may be configured with zero, one, or more SR configurations. An SR configuration consists of a set of physical uplink control channel (PUCCH) resources for SR across different bandwidth parts (BWPs) and cells. For a logical channel or for secondary cell (SCell) beam failure recovery and for consistent listen before talk (LBT) failure recovery, at most one physical uplink control channel (PUCCH) resource for SR is configured per BWP.

Each SR configuration corresponds to one or more logical channels and/or to SCell beam failure recovery and/or to consistent LBT failure recovery. Each logical channel, SCell beam failure recovery, and consistent LBT failure recovery, may be mapped to zero or one SR configuration, which is configured by radio resource control (RRC). The SR configuration of the logical channel that triggered a buffer status report (BSR) or SCell beam failure recovery or the consistent LBT failure recovery (if such a configuration exists) is considered as the corresponding SR configuration for the triggered SR. Any SR configuration may be used for an SR triggered by Pre-emptive BSR.

### Buffer Status Report

The BSR procedure is used to provide the serving gNB with information about uplink (UL) data volume in the medium access control (MAC) entity of a UE. In the case of integrated access and backhaul (IAB), it is additionally used by an IAB-MT (mobile termination) to provide its parent LAB-DU (distributed unit) with information about the amount of the data expected to arrive at the MT of the IAB node from its child node(s) and or UE(s) connected to it. This BSR is referred to as Pre-emptive BSR.

Each logical channel may be allocated to a logical channel group (LCG) using the logicalChannelGroup field. The maximum number of LCGs is eight. The MAC entity determines the amount of uplink (UL) data available for a logical channel according to the data volume calculation procedure.

### SUMMARY

One object is to provide an improved communications network. Another object is to provide an improved transmission of data flow within a wireless communication network.

A method of operating a wireless device that is configured for transmission of a data flow within a wireless communication network is provided. The method includes receiving a data packet of the data flow from an application, wherein the data flow includes application data units (ADUs), each of which includes a plurality of related data packets, and storing the data packet in a buffer of the wireless device. The method further includes obtaining ADU related information about a relationship between the data packet and a related ADU to which the data packet belongs, and notifying a network node of the wireless communication network about the data packet based on the ADU related information. Hereby is provided an improved method of notifying a network node about data packets, thereby providing an improved communications network.

The ADU related information includes one or more of: an association of the data packet to the related ADU, an indication of whether all data packets carrying the related ADU have been buffered by the wireless device, an indication of a number of data packets carrying the related ADU that have been buffered by the wireless device, an indication of a total number of data packets associated with the related ADU, a priority associated with the related ADU, and/or a number of ADUs that are fully or partially buffered in the wireless device.

In some embodiments, notifying the network node includes transmitting a scheduling request, SR, to the network node indicating that the wireless device has buffered data for transmission.

The method may further include determining whether a number of packets belonging to the ADU greater than a threshold number have been buffered, wherein transmitting the SR is performed only if the number of packets belonging to the ADU that have been buffered is greater than the threshold.

In some embodiments, the related ADU has an associated packet delay budget, PDB, wherein the SR is only triggered if the number of packets belonging to the ADU that have been buffered is greater than the threshold before expiration of the PDB.

In some embodiments, the related ADU has an associated packet delay budget, PDB, wherein the SR is only triggered if the number of packets belonging to the ADU that have been buffered is greater than the threshold and a remining PDB is greater than a PDB threshold.

The method may further include transmitting the ADU related information to the network node together with the SR.

In some embodiments, the ADU related information is transmitted to the network node in a header or other signaling mechanism.

In some embodiments, the wireless device receives data packets belonging to two different ADUs, and wherein the SR is sent only when a SR condition relating to the two different ADUs is met.

In some embodiments, the SR is sent at least in part based on a priority of the related ADU.

In some embodiments, the SR is configured with a minimum buffer size threshold min_threshold and a maximum buffer size threshold max_threshold, such that the SR is only triggered if min_threshold<buffer_size<=max_threshold, where buffer_size is a size of a buffer in which data packets are stored.

In some embodiments, notifying the network node about the buffered packet includes transmitting the ADU related information to the network node.

In some embodiments, the ADU related information includes one or more of: a bitfield that represents a number of ADUs that are fully buffered at the wireless device, a bitfield that represents a number of ADUs that are fully or partially buffered at the wireless device, a bitfield that indicates that at least one ADU is fully buffered at the wireless device, a bitfield that indicates a priority of a data packet or ADU that is fully buffered at the wireless device, a bitfield that indicates a priority of a data packet or ADU that is fully or partially buffered at the wireless device, a bitfield that indicates an inter-dependency between the related ADU and another ADU, a bitfield that indicates a late delivery indication relating to the ADU, a bitfield that indicates jitter information relating to the related ADU, a bitfield that indicates a remaining two-way delay budget associated with the related ADU, and a bitfield that indicates a content criteria associated with the related ADU.

In some embodiments, the content criteria relates to handling of decoding errors of data packets in the ADU.

In some embodiments, the ADU related information includes one or more of: a bitfield that indicates application rate-adaptation related events, a bitfield that indicates information related to previous experiences of the wireless device with uplink grants, a bitfield that indicates information about dropped ADUs in the wireless device, and a bitfield that indicates information about a number of ADUs in the buffer of the wireless device and a buffer size for each of the buffered ADUs.

The method may further include providing user data, and forwarding the user data to a host via the transmission to the network node.

A method of operating a network node in a wireless communication network is provided. The method includes configuring a wireless device to receive a data packet of a data flow from an application, wherein the data flow includes application data units (ADUs), each of which includes a plurality of related data packets, configuring the wireless device to store the data packet in a buffer of the wireless device, configuring the wireless device to obtain ADU related information about a relationship between the data packet and a related ADU to which the data packet belongs, and receiving a notification about the data packet from the wireless device, wherein the notification was transmitted based on the ADU related information.

Some embodiments provide a wireless device including a processing circuit, a transceiver coupled to the processing circuit, and a memory coupled to the processing circuit. The memory includes computer readable program instructions that, when executed by the processing circuit, cause the wireless device to perform operations including receiving a data packet of the data flow from an application, wherein the data flow includes application data units (ADUs), each of which includes a plurality of related data packets, storing the data packet in a buffer of the wireless device, obtaining ADU related information about a relationship between the data packet and a related ADU to which the data packet belongs, and notifying a network node of the wireless communication network about the data packet based on the ADU related information.

Some embodiments provide a network node including a processing circuit, a transceiver coupled to the processing circuit, and a memory coupled to the processing circuit. The memory includes computer readable program instructions that, when executed by the processing circuit, cause the network node to perform operations including configuring a wireless device to receive a data packet of a data flow from an application, wherein the data flow includes application data units (ADUs), each of which includes a plurality of related data packets, configuring the wireless device to store the data packet in a buffer of the wireless device, configuring the wireless device to obtain ADU related information about a relationship between the data packet and a related ADU to which the data packet belongs, and receiving a notification about the data packet from the wireless device, wherein the notification was transmitted based on the ADU related information.

Some embodiments provide a computer program product, including a non-transitory computer readable storage medium containing computer-readable program instructions that, when executed on a processing circuit, perform operations as described above.

### BRIEF DESCRIPTION OF THE DRAWINGS

FIG. 1 is a block diagram that illustrates a simplified communication system.

FIGS. 2 and 3 illustrate Buffer Status Report formats according to some embodiments.

FIG. 4 illustrates a method of operating a wireless device that is configured for transmission of a data flow within a wireless communication network according to some embodiments.

FIG. 5 illustrates a method of operating a network node in a wireless communication network according to some embodiments.

FIG. 6 shows an example of a communication system in accordance with some embodiments.

FIG. 7 shows a UE in accordance with some embodiments.

FIG. 8 shows a network node in accordance with some embodiments.

FIG. 9 is a block diagram of a host in accordance with various aspects described herein.

FIG. 10 is a block diagram illustrating a virtualization environment in which functions implemented by some embodiments may be virtualized.

FIG. 11 shows a communication diagram of a host communicating via a network node with a UE over a partially wireless connection in accordance with some embodiments.

### DETAILED DESCRIPTION OF EMBODIMENTS

Currently, the scheduler in the gNB allocates resources for users based on delay requirements, availability of data in buffer and size of data in buffer, and fairness of resource share considering the given QoS. However, it may be beneficial for a schedule to consider other information relating to XR and media traffic, such as the availability of a entire ADU or media unit in the buffer, how many ADUs/media units are in buffer, the priority of an ADU/media unit for the application (e.g., whether it represents an I-frame or P-frame) and/or the remaining delay for the time critical data. For uplink XR/media traffic, such information currently is not available at gNB.

Certain aspects of the disclosure and their embodiments may provide solutions to these or other challenges. With advanced knowledge of XR application data and media traffic in general (via application awareness) arriving in a UE buffer, the UE may transfer useful information related to buffered data to the network via SR or BSR. For example, the UE may communicate the number of ADUs/media units in the buffer, whether an entire ADU/PDU set is buffered, and/or the priority of an ADU/media unit in the buffer. This information can be used by the scheduler for more efficient resource planning and/or for maximizing capacity.

Some embodiments provide a method of operating a wireless device (e.g., a user equipment, or UE), in which the UE is configured for transmission of a data flow consisting of ADUs or media units such that a relation between each buffered packet and ADU or media unit is provided to or known by the UE. According to some embodiments, the UE make an assessment/analysis of buffered data and signals ADU/media unit related information to the network via an SR or BSR.

Some embodiments provide a method of operating a network node, such as a gNB, that includes receiving ADU/media unit related information from a UE via an SR or BSR and making a scheduling decision based on the ADU/media unit related information. In some embodiments, the network node may send a scheduling grant to the UE that is based on the ADU/media unit related information received from the UE.

Certain embodiments may provide one or more of the following technical advantage(s). When information about ADUs/PDU sets buffered in the UE is available at the scheduler, potentially coupled with also delay information, the scheduler can perform more efficient prioritization between different UEs connected to the network to increase the system capacity. For example, if one UE has two buffered ADUs/media units while other connected UEs have one or zero buffered ADUs/media units and those units have different delay targets, a gNB can prioritize UEs with different numbers of buffered units and/or delay availability.

Some of the embodiments contemplated herein will now be described more fully with reference to the accompanying drawings. Embodiments are provided by way of example to convey the scope of the subject matter to those skilled in the art.

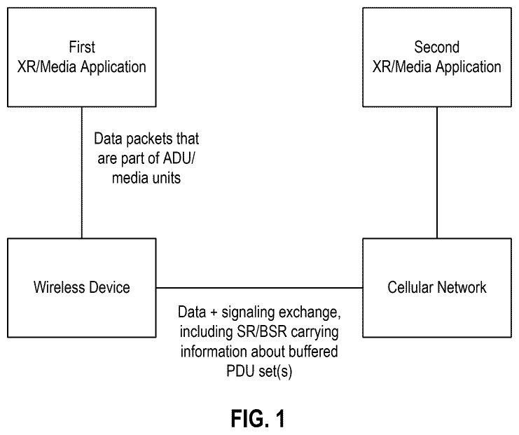

A simplified system is illustrated in FIG. 1. In FIG. 1, a first XR/media application operating at a wireless device (e.g., a user equipment, or UE) sends data packets to a second XR/media application via a cellular network. The second XR/media application may be operating on a second wireless device, a network node, or another device accessible through a packet data network. The XR/media application and wireless device on a transmission side can be parts of the same device, such as AR glasses, in which case data packets between the application and the wireless device are carried by internal interface. An XR/media application receiving data packets can be located, for example, in a cloud, which is connected with cellular network via data transmission interface(s).

The XR/media application generates ADU/media units for transmission which may be relatively large in size (e.g., >10 Kbytes). There are very many interfaces in communication networks that operate based on Ethernet, which has a maximum transfer unit (MTU) size of 1500 Bytes. Thus, XR/media application ADU/media units must be segmented into shorter data packets having a size less than the maximum Ethernet MTU.

For purposes of the present disclosure, it is assumed that there is a signaling mechanism (such as extra information in a header) or another method which makes it possible for the wireless device to be aware of ADU/media unit segmentation and/or to derive one or more of the following information:
Association of each data packet to an ADU/media unit. Here the term “data packet” can be IP-packets, protocol data units (PDUs) or service data units (SDUs) of the GTP-U, PDCP, SDAP or RLC protocol layers.
Whether all data packets carrying one ADU/media unit arrived in the device buffer.
The priority of ADU/media units buffered at the UE (e.g., a priority value provided by the application).
The number of ADUs/media units fully or partially buffered in wireless device.

Some embodiments enhance SR and/or BSR signaling to communicate information about ADU/media units buffered at a UE to the network via a gNB. In the 5G New Radio (NR) specification, an SR is conditioned when (a) a BSR is triggered and (b) the BSR cannot be transmitted, for example, because there are no uplink shared channel (UL-SCH) resources that can be used to send the BSR. Thus, when phrases such as “send SR based on”, “SR triggered by” etc., are used herein, it should be understood that the triggering condition is with respect to a BSR.

### Sending SR Based on ADU/Media Unit Availability in the Buffer.

An SR is used by a UE for requesting UL-SCH resources for new transmission. The UE's MAC triggers an SR when a regular BSR is triggered and UE does not have uplink resources for transmission of at least the regular BSR. A regular BSR is triggered when data becomes available for transmission in the uplink. An SR comprises one bit in uplink control information (UCI) transmitted by a UE on the physical uplink control channel (PUCCH) or the physical uplink shared channel (PUSCH).

Since an ADU/media unit may arrive at a UE in multiple packets/PDUs with some delay between them, it may be beneficial to wait to send an SR until an ADU/media unit is fully buffered or about to be fully buffered (e.g., 80% percent of the ADU is buffered and last part is expected to come soon or x out of y packets are buffered, such that x>x_threshold, and x_threshold<y). In this case, a wireless device can be configured with one or more parameters that can be used to determine when to send an SR or when data are available for transmission in radio interface.

In one embodiment, the packet delay budget (PDB) of an ADU is defined as an absolute parameter, which means that in all the buffered data, y packets of an ADU have the same PDB absolute value. Thus, when an SR is triggered, it should be within the PDB. For example, assume an ADU media unit is divided into y=10 packets with a PDB of 15 ms, and x_threshold is set at 7 packets, so the SR will be triggered when 7 packets have been received in the buffer. Assume the first packet arrives after 1 ms (so that the remaining PDB is 14 ms). The UE cannot trigger an SR, as it has to wait for at least 6 more packets in the buffer. However, if when the 7th packet arrives, the PDB of 15 ms has already been passed, then the SR will not be triggered.

In one embodiment, the UE is provided with “PDB left” threshold for SR configuration, and the SR can be triggered only if the remaining packet delay budget for an ADU or a packet data convergence protocol (PDCP) PDU is less than a configured threshold. This delay threshold can be coupled with one or more of the other thresholds (e.g., percentage of ADU threshold described in previous embodiment, buffered data threshold and priority thresholds described in next embodiments). That is, in some embodiments, multiple threshold conditions need to be met for triggering of SR.

In one embodiment, an SR mechanism is defined in connection with ADUs related to different packet types, such as when one ADU belongs to a video I/frame slice, and another ADU belongs to an audio type.

It is further defined that additional information should be included in a header or other signaling mechanism, which indicates that these ADUs or packets have a correlation or dependence on one another, as they are sourced from the same application at a given time instant or time period.

In some embodiments, an SR is triggered subject to different ADU types in buffered data. For example, x1 out of y1 packets of audio ADU are buffered, and x2 out of y2 packets of video ADU are buffered. In some embodiments, the UE is expected to send an SR if “buffered data x2>x2_therehold AND buffered data x1>x1_threshold”, where x2_threshold<y2 and x1_threshold<y1. Upon receiving the SR, the gNB may provide a scheduling grant for both expected video and audio data packets/SDU. The reason to include both audio and video ADU in the condition is that the quality of experience (QoE) in this example depends on both audio and video reception.

In some embodiments, the UE is expected to send an SR if buffered data x2>x2_threshold, where x2_threshold<y2.

Upon receiving the SR, the gNB provides a grant for both expected video and audio data packets/SDU. Here, audio buffered dependence is not included in SR trigger mechanism, as audio ADU would be of negligible size.

In one embodiment, the UE is provided with guidance to trigger an SR depending on ADU priority. For example, the UE may send an SR only if the ADU priority is equal to or higher than certain value. For example, an SR can be triggered only for I-frames if a logical channel carries video traffic.

In one embodiment, given x packets out of y packets are buffered, a UE can send an SR/BSR indicating a value for ‘x’ or a function value that depends on the value of ‘x’.

In one embodiment, given x packets out of y packets are buffered, where x is less than x_threshold, i.e., x<x_threshold, a UE can send a “negative SR”.

In one embodiment, an SR is configured with a minimum buffer size threshold and a maximum buffer size threshold, min_threshold and max_threshold, such that an SR is only triggered if min_threshold<buffer_size<=max_threshold. If min_threshold is not configured, then UE may assume min_threshold=0, and if max_threshold is not configured then UE may assume max_threshold to be unlimited.

Further, in embodiments where the SR buffer size range can be configured, a gNB can be allowed to configure a UE with multiple SR configurations per one logical channel, such that if buffer size is in the range [x_i, x_(1+1)], then UE sends an SR for SR configuration i. For example, the gNB may want to know if a UE has data and if its buffer exceeds x or not. Then, the gNB configures the UE with SR configuration #1: [min_threshold, max_threshold]=[0, x bytes] or SR configuration #2: [min_threshold, max_threshold]=[x bytes, unlimited].

### BSR Extension

Since a BSR may carry many bits, in contrast to the one-bit SR, some embodiments communicate information to a gNB about buffered ADUs/media units in a BSR. For this purpose, the current BSR structure specified in [2] can be enhanced, or a new MAC information element (IE) can be added (e.g., an ADU-related BSR IE). The information which can be carried by an enhanced BSR or new extended BSR, or a new MAC control element, may consist of one or more of the following.
1. A bitfield representing the number of ADUs/media units that are fully or partially buffered in wireless device. Each codepoint may directly indicate number of ADUs/media units or may indicate a range.

Examples of such a bitfield are shown in Table 1 and Table 2.

TABLE 1
Example bitfield representing a number of ADUs/media units
that are fully or partially buffered in a wireless device.

| Bitfield in BSR | Number of ADUs/media units |
|---|---|
| 00 | 0 is fully buffered |
| 01 | 1 is fully buffered |
| 10 | 2 are fully buffered |
| 11 | more than 2 are fully buffered |

TABLE 2
Example bitfield representing a number of ADUs/media units
that are fully or partially buffered in a wireless device.

| Bitfield in BSR | Number of ADUs/media units |
|---|---|
| 00 | 0.5 is buffered |
| 01 | 1 is fully buffered |
| 10 | 1.5 is buffered |
| 11 | 2 or more are fully buffered |

2. A bitfield representing that at least one ADU/media unit is fully buffered, e.g., “0”—no fully buffered ADUs, “1”—one or more fully buffered ADUs (at least one).

In one embodiment, extending the examples shown in Tables 1 and 2, bitfield interpretation can be made dynamic. For example, RRC parameter(s) can be defined which selects the define interpreting value for the codewords in the bitfield. In a cell, assume there are 2 UEs, for one UE, codeword 00 is referred to 0 ADU is fully buffered as per RRC parameter setting, and for other UE, codeword “00” referred to 0.5 ADU is buffered. Tables 3 and 4 illustrate examples of dynamic setting.

TABLE 3
Example of dynamic setting of bitfields

| Bitfield in BSR | Number of ADUs/media units |
|---|---|
| 00 | B 1 is fully buffered |
| 01 | B 2 is fully buffered |
| 10 | B 3 is fully buffered |
| 11 | B 4 is fully buffered |

The values B1-B4 are configured by some RRC parameter for a given UE.

Table 4 is an example RRC table depicting vales of B1-B4 indicating ADU unit values.

TABLE 4
RRC table depicting vales of B 1-B 4 indicating ADU unit values.

| Number of ADUs/media units | Value |
|---|---|
| B 1 | 0 to 1 |
| B 2 | 1 to 2 |
| B 3 | 2 to 5 |
| B 4 | 5 or more |

3. A bitfield showing the priority of buffered (partially buffered) ADU/media unit provided by the application. There can be different options how to transmit the priority in BSR. For example, the UE may send priority indication even if an ADU is partially buffered or send a priority indication when an ADU is fully buffered, or when a certain percentage of an ADU is buffered.

If more than one ADU is fully/partially buffered, the UE can send a priority of every ADU (multiple fields) or send only one value of priority, e.g., a highest priority of buffered ADUs.
4. A bitfield representing inter dependencies between two or more ADUs. For example, if two or more consecutive or non-consecutive ADU's depend on each other, they can indicate this by carrying each other's ADU ID, For example, ADU #2 may carry ADU #1 ID number in a multi-bit field indicating that ADU #2 is completely dependent on the successful reception of ADU #1.
5. Late delivery indication bitfield to indicate whether buffered ADU(s) needs to be delivered even after a deadline, i.e., even if the total delay will exceed packet delay budget. If late delivery is not indicated, the ADU should be delivered within the PDB or else can be dropped. Transmitting this information in a BSR can enable the gNB to prioritize the UE. In the opposite case, if late delivery is still beneficial for the application, the gNB can plan resources accordingly, e.g., scheduling the UE at low throughput in order to prioritize other transmissions in the system.
6. A bitfield about jitter information.

One example of such a bitfield my carry a range of jitter in time units (milliseconds), or parameters of a Gaussian distribution of jitter: mean, standard deviation (std) or sigma.

Another example is to signal one bit indicating whether an ADU is coming earlier than an average arrival or later than an average arrival. This also can be done by a multi-bit field where the value is indicated in time units (e.g. 2 ms earlier or 1 ms later than average).

Jitter information can also be provided indirectly, e.g., as remaining one way-PDB in coded time units (milliseconds).
7. A remaining two-way delay budget associated with given ADU instead of one-way.
8. A bitfield representing a content criteria, such as information that for a given buffered ADU, a reduced BLER requirement applies.

The content criteria may be a single bit flag that indicates if a single PDU decoding error renders remaining ADU useless to the application (assuming one ADU consists of multiple PDU's).

The content criteria may be a single bit flag indicating if Forward Error Correction (FEC) is used on the ADU.

Assuming the Transport Block (TB) is segmented with a Cyclic Redundancy Check (CRC) attached to each segment, and assuming also that the application layer implements a forward error correction (FEC) scheme, the bitfield may indicate a number or percentage of segments whose CRCs need to be decoded successfully. The gNB could then potentially accept a certain number of erroneous segments without triggering a retransmission.
9. A bitfield indicating application rate-adaptation related events, such as an explicit Congestion Notification (ECN) field of buffered IP-packets associated with ADU can be forwarded via BSR, or a flag indicating whether buffered ADU has new parameters, i.e., arrived after change of rate at application.

Alternatively, the bitfield may indicate how the application layer rate has changed, e.g. increased or decreased.

In yet another alternative, the application pre-shares all possible application rates with RAN, such that every application rate has its own index. For example, there can be different video profiles: 1=HD video, 2=Full HD video, 3=4K video etc. When an ADU associated with a profile is buffered at the UE, an index of the profile is forwarded in BSR as a bitfield.
10. A bitfield with information about previous experience with UL grants. For example, the bitfield may indicate an average delay between ADU arrival in the buffer and UL grant when this ADU is sent. This measurement can be configured in several ways.

In some embodiments, a gNB can configure an averaging window in time units (milliseconds), in number of UL grants or number of ADUs. This measurement can be applied only to configured grants, only to dynamic grants or to all types of grants.

If multiple grants are needed to send one ADU, the UE can be instructed to measure the time between the ADU arrival at the buffer and (a) the first UL grant where ADU transmission started, and/or (b) the last grant where ADU transmission finished. This information may help gNB to detect systematic delays in granting and estimate an expected (average) arrival time of ADUs.
11. A bitfield with information about dropped ADUs in the UE. If the delay budget for the ADU has expired before receiving the UL grant or if the UE decides that the ADU cannot be received within its deadline, the UE may drop the entire ADU. In this embodiment, the UE can signal it has dropped one or more ADU(s) in its buffer. The information can be used in the gNB to update the Error Rate statistic.

In one embodiment, a multi-bit field can signal the total number of ADUs dropped thus far in the XR session. This number may wrap around depending on the number of bits in the field.

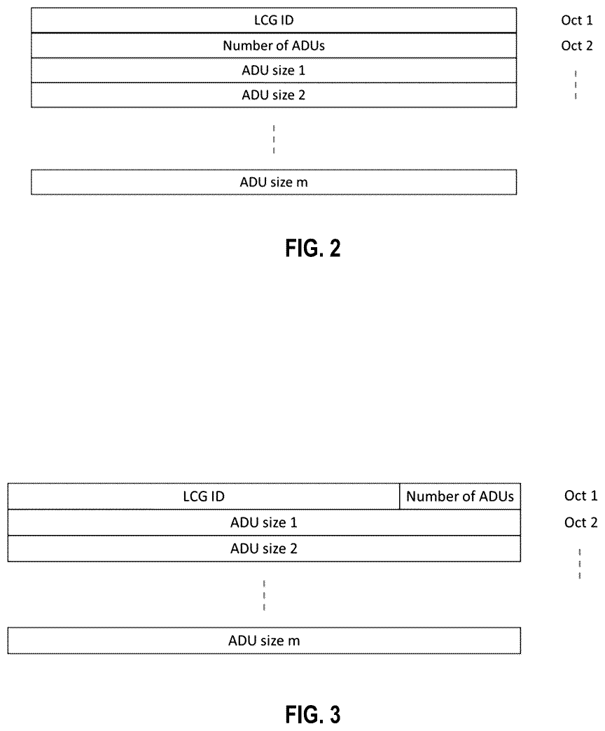

In another embodiment, a multi-bit field can indicate the number of dropped ADU's in a time window, that is statically configured.
12. A combination of bitfields indicating number of ADUs in the UE buffer and multiple bitfields indicating the buffer size for each of ADUs. For example, an ADU-based BSR could be formatted as shown in FIG. 2, where a Logical Channel Group ID (LCG ID) is the logical channel group identity and where m is the number of ADUs indicated by the field “Number of ADUs”. The LCG ID field identifies the group of logical channel(s) whose buffer status is being reported.

The fields “ADU size 1” to “ADU size m” may be ordered such that “ADU size 1” is the buffer size for the ADU that arrived earliest (or, last) to UE buffer. In above example, the number of different values of number of ADUs that the BSR can indicate is 8, e.g. 1, 2, . . . , 8 or 1, 2, 4, 6, . . . , 14. In some example, only a few ADUs may be expected to be in the UE buffer when the UE triggers the BSR. In such examples, the formatting of the BSR may look as shown in FIG. 3.

In above embodiment, the logical channel may be configured as “adu_enabled” and if enabled, the UE sends an ADU (-based) BSR, e.g. a BSR formatted as illustrated by the examples above.

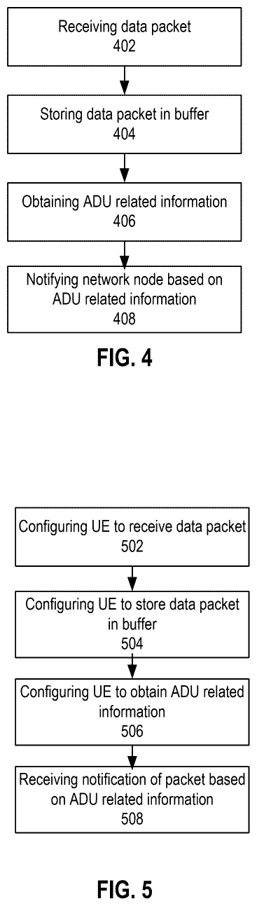

FIG. 4 illustrates a method of operating a wireless device that is configured for transmission of a data flow within a wireless communication network. Referring to FIG. 4, the method includes receiving 402 a data packet of the data flow from an application, wherein the data flow comprises ADUs, each of which comprises a plurality of related data packets, and storing 404 the data packet in a buffer of the wireless device. The wireless device obtains 406 ADU related information about a relationship between the data packet and a related ADU to which the data packet belongs, and notifies 408 a network node of the wireless communication network about the data packet based on the ADU related information.

FIG. 5 illustrates a method of operating a network node in a wireless communication network. Referring to FIG. 5, the method includes configuring 502 a wireless device to receive a data packet of a data flow from an application, wherein the data flow comprises application data units (ADUs), each of which comprises a plurality of related data packets and configuring 504 the wireless device to store the data packet in a buffer of the wireless device. The network node configures 506 the wireless device to obtain ADU related information about a relationship between the data packet and a related ADU to which the data packet belongs, and receives 508 a notification about the data packet from the wireless device, wherein the notification was transmitted based on the ADU related information.

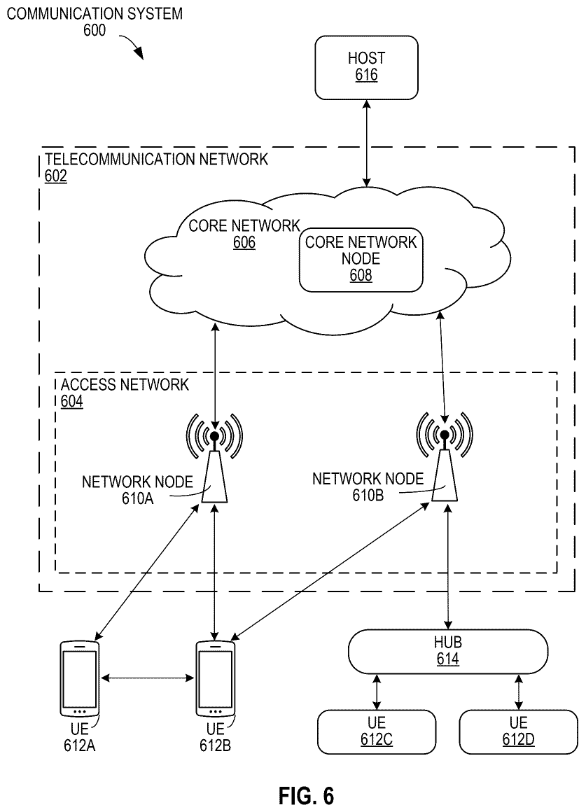

FIG. 6 shows an example of a communication system 600 in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access node or non-3GPP access point. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

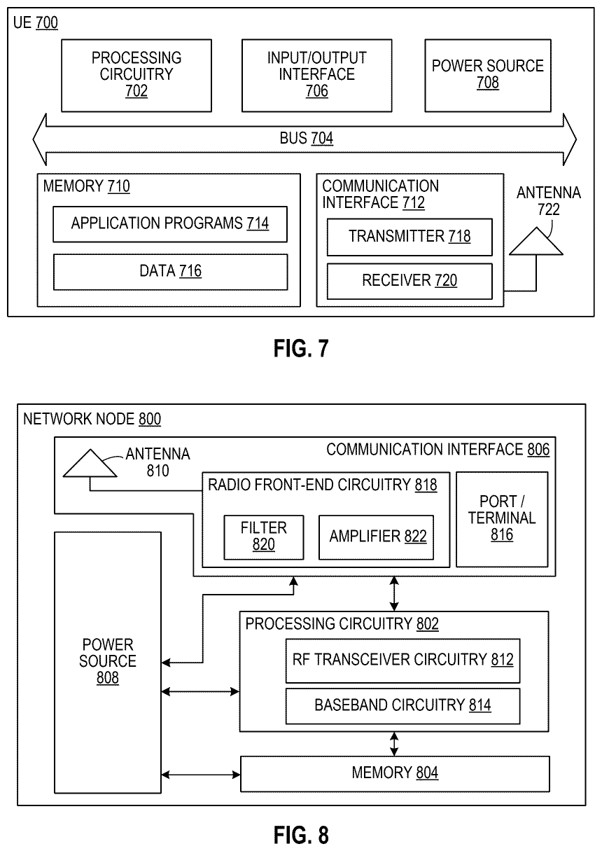

FIG. 7 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

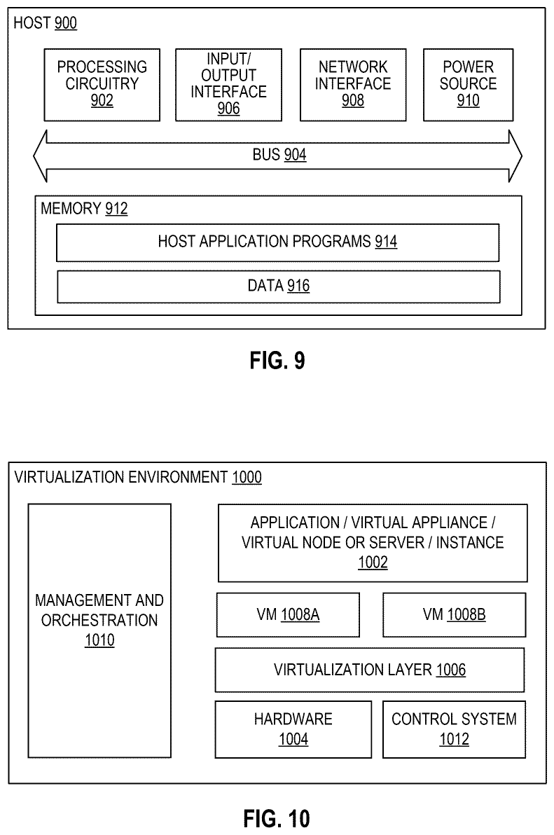

FIG. 9 is a block diagram of a host 900, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g. such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

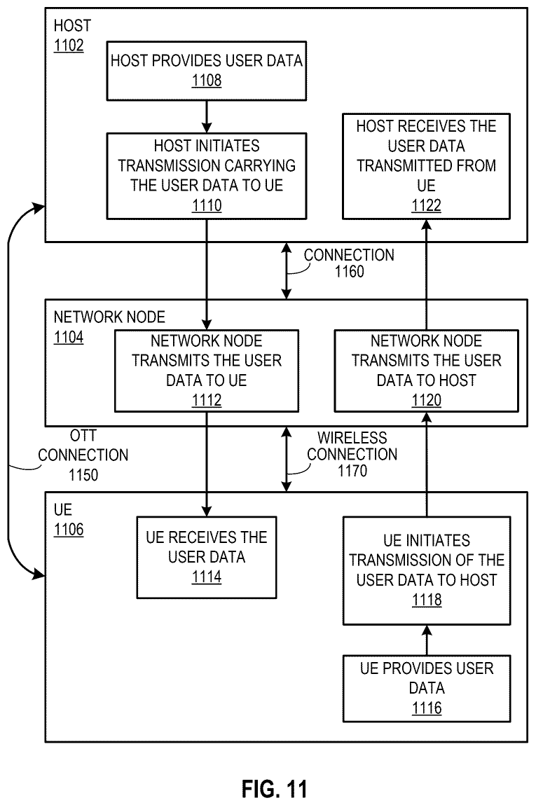

FIG. 11 shows a communication diagram of a host 1102 communicating via a network node 1104 with a UE 1106 over a partially wireless connection in accordance with some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UB 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the ability of a scheduler in a gNB to schedule transmissions of ADU/media units more efficiently, and thereby provide benefits such as improved user experience.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights), As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### REFERENCES

1. S2-2109360, New SID on Study on architecture enhancement for XR and media services, November 2021
2. 3GPP TS 38.321, Medium Access Control (MAC) protocol specification (Release 16), v. 16.5.0

1. A method of operating a wireless device that is configured for transmission of a data flow within a wireless communication network, the method comprising:
receiving a data packet of the data flow from an application, wherein the data flow comprises application data units, ADUs, each of which comprises a plurality of related data packets;
storing the data packet in a buffer of the wireless device;
obtaining ADU related information about a relationship between the data packet and a related ADU to which the data packet belongs; and
notifying a network node of the wireless communication network about the data packet based on the ADU related information, wherein notifying the network node comprises transmitting a scheduling request, SR, to the network node indicating that the wireless device has buffered data for transmission.

2. The method of claim 1, wherein the ADU related information comprises one or more of:
an association of the data packet to the related ADU;
an indication of whether all data packets carrying the related ADU have been buffered by the wireless device;
an indication of a number of data packets carrying the related ADU that have been buffered by the wireless device;
an indication of a total number of data packets associated with the related ADU;
a priority associated with the related ADU; and/or
a number of ADUs that are fully or partially buffered in the wireless device.

3. (canceled)

4. The method of claim 1, further comprising determining whether a number of packets belonging to the ADU greater than a threshold number have been buffered, wherein transmitting the SR is performed only if the number of packets belonging to the ADU that have been buffered is greater than the threshold.

5. The method of claim 1, wherein the related ADU has an associated packet delay budget, PDB, wherein the SR is only triggered if the number of packets belonging to the ADU that have been buffered is greater than the threshold before expiration of the PDB.

6. The method of claim 1, wherein the related ADU has an associated packet delay budget, PDB, wherein the SR is only triggered if the number of packets belonging to the ADU that have been buffered is greater than the threshold and a remining PDB is greater than a PDB threshold.

7-8. (canceled)

9. The method of claim 1, wherein the wireless device receives data packets belonging to two different ADUs, and wherein the SR is sent only when a SR condition relating to the two different ADUs is met.

10-11. (canceled)

12. The method of claim 1, wherein notifying the network node about the buffered packet comprises transmitting the ADU related information to the network node.

13-27. (canceled)

28. The method of claim 1, further comprising:
providing user data; and
forwarding the user data to a host via the transmission to the network node.

29. A method of operating a network node in a wireless communication network, comprising:
configuring a wireless device to receive a data packet of a data flow from an application, wherein the data flow comprises application data units, ADUs, each of which comprises a plurality of related data packets;
configuring the wireless device to store the data packet in a buffer of the wireless device;
configuring the wireless device to obtain ADU related information about a relationship between the data packet and a related ADU to which the data packet belongs; and
receiving a notification about the data packet from the wireless device, wherein the notification was transmitted based on the ADU related information, wherein receiving the notification comprises receiving a scheduling request, SR, from the wireless device indicating that the wireless device has buffered data for transmission.

30. The method of claim 29, wherein the ADU related information comprises one or more of:
an association of the data packet to the related ADU;
an indication of whether all data packets carrying the related ADU have been buffered by the wireless device;
an indication of a number of data packets carrying the related ADU that have been buffered by the wireless device;
an indication of a total number of data packets associated with the related ADU;
a priority associated with the related ADU; and/or
a number of ADUs that are fully or partially buffered in the wireless device.

31. (canceled)

32. The method of claim 29, wherein receipt of the SR indicates that a number of packets belonging to the ADU that have been buffered by the wireless device is greater than a threshold.

33. The method of claim 29, wherein the related ADU has an associated packet delay budget, PDB, wherein the SR is only triggered if the number of packets belonging to the ADU that were buffered by the wireless device is greater than the threshold before expiration of the PDB.

34. The method of claim 29, wherein the related ADU has an associated packet delay budget, PDB, wherein the SR is only triggered if the number of packets belonging to the ADU that were buffered by the wireless device is greater than the threshold and a remining PDB is greater than a PDB threshold.

35. (canceled)

36. The method of claim 29, wherein the ADU related information is received in a header or other signaling mechanism.

37-38. (canceled)

39. The method of claim 29, wherein receiving the notification comprises receiving the ADU related information from the wireless device.

40-54. (canceled)

55. A wireless device, comprising:
a processing circuit;
a transceiver coupled to the processing circuit; and
a memory coupled to the processing circuit, wherein the memory comprises computer readable program instructions that, when executed by the processing circuit, cause the wireless device to perform operations comprising:
receiving a data packet of the data flow from an application, wherein the data flow comprises application data units, ADUs, each of which comprises a plurality of related data packets;
storing the data packet in a buffer of the wireless device;
obtaining ADU related information about a relationship between the data packet and a related ADU to which the data packet belongs; and
notifying a network node of the wireless communication network about the data packet based on the ADU related information, wherein notifying the network node comprises transmitting a scheduling request, SR, to the network node indicating that the wireless device has buffered data for transmission.

56. (canceled)

57. A computer program product, comprising a non-transitory computer readable storage medium containing computer-readable program instructions that, when executed on a processing circuit, perform operations according to claim 1.

58. A network node, comprising:
a processing circuit;
a transceiver coupled to the processing circuit; and
a memory coupled to the processing circuit, wherein the memory comprises computer readable program instructions that, when executed by the processing circuit, cause the network node to perform operations comprising:
configuring a wireless device to receive a data packet of a data flow from an application, wherein the data flow comprises application data units, ADUs, each of which comprises a plurality of related data packets;
configuring the wireless device to store the data packet in a buffer of the wireless device;
configuring the wireless device to obtain ADU related information about a relationship between the data packet and a related ADU to which the data packet belongs; and receiving a notification about the data packet from the wireless device, wherein the notification was transmitted based on the ADU related information, wherein receiving the notification comprises receiving a scheduling request, SR, from the wireless device indicating that the wireless device has buffered data for transmission.

59. (canceled)

60. A computer program product, comprising a non-transitory computer readable storage medium containing computer-readable program instructions that, when executed on a processing circuit, perform operations according to claim 29.
